(19) United States
(12) Patent Application Publication
(10) Pub. No.: US 2010/0185438 A1
(43) Pub. Date: Jul. 22, 2010

(54) METHOD OF CREATING A DICTIONARY

(75) Inventor: JOSEPH A DE LA CRUZ, Medford, NJ (US)

Correspondence Address: JOSEPH DE LA CRUZ, 1 WALNUT ROAD, MEDFORD, NJ, 08055, US

(73) Assignee: JOSEPH ANTHONY DELACRUZ, Medford, NJ (US)

(21) Appl. No.: 12/357,378

(22) Filed: Jan. 21, 2009

(51) Int. Cl. G06F 17/21

(52) U.S. Cl. 704/10

(57) ABSTRACT

An apparatus, program product and method for creating a dictionary. The method may be performed automated, semi-automated or manually. Dictionary allows entries to be stored with a plurality of data elements.

### CROSS-REFERENCE TO RELATED APPLICATIONS

Not applicable.

### FIELD OF INVENTION

The present invention relates to a method for creating one or more dictionaries.

### BACKGROUND OF THE INVENTION

Dictionaries have remained unchanged for hundreds of years. Dictionaries consist of comprehensive collections of words and are specific to a single language. As a result, dictionaries include the vast majority of spoken and written words for a single language.

Dictionary entries are not filtered by parts-of-speech criteria. More specifically, dictionaries do not limit entries to proper names; furthermore, dictionaries do not include proper names unless such names have historical significance.

Over time, the format of dictionaries has been standardized. Entries have a lemma associated with each entry. The lemma is modified using affixes or suffixes and allows a plurality of words to be constructed from each lemma. Additionally, affixes and suffixes allow the user to conjugate the lemma to other word forms.

Some dictionaries provide related information about entries such as the word definition, pronunciation or parts-of-speech information.

Electronic versions of dictionaries are common and are used in computer applications such as spell checking and optical character recognition programs. These electronic dictionaries also use lemma construction methods.

Proper names are a specialized parts-of-speech category. It is not possible to create a lemma configuration of proper names. Additionally, they can not be conjugated like verbs; and unlike nouns, verbs, adjectives and other parts-of-speech; proper names may be composed of several individual words. Blank spaces between individual words in a proper name are a critical part of their makeup; modifying or deleting the blank spaces alters the accuracy of the data. Parsing a proper name into two or more individual words would cause the original entry to be broken into individuals words thus loosing the original intent of the entry. For example, “General Motors” is a proper name—parsing “General Motors” into general and motors, replaces a proper name with two words—general and motors. The original intent of the entry is lost forever and the accuracy of the dictionary has been compromised.

Proper names are not limited to a specific language. The word “Colorado” is English and appears in English dictionaries. An individual may be required to read, speak or write proper nouns that are not part of his native language. Such proper names are not included in a dictionary for the individual's native language. For example, a Chinese company may need to ship a package to Colorado and will therefore need a dictionary that has the correct spelling of “Colorado”. It is unlikely that any Chinese dictionary will provide the accurate spelling for “Colorado”.

A dictionary restricted to proper names, and not limited to a specific language whether written, electronic, or stored in a computer readable and retrievable format, will be enormously useful. Such a dictionary would benefit from a format adapted specifically for challenges related to proper names.

Based on the above examples, a dictionary composed entirely of proper names can be used independent of language and have enormous usefulness and application. The dictionary can be electronic, written or be integrated into a computer application.

Current dictionaries that consist of lemmas, affixes and suffixes are not well suited for proper names. These dictionaries utilize a complex methodology where root words are stored in the dictionary and variations are constructed on-the-fly when searching for a word with a matching root or lemma. Therefore, a large improvement will be realized from the creation of a dictionary without lemmas, affixes and suffixes.

A data element used as a measure of the frequency of occurrence of proper names in written and spoken language is important. Frequency of occurrence can be defined as frequency of usage or occurrence in written or spoken language of proper names relative to each other or stated differently the frequency of occurrence in common usage. For example, Joe is more commonly used than Emanuel; therefore Joe has a higher frequency of occurrence.

Current dictionaries provide pronunciation based on pronunciation keys. A dictionary of proper names would greatly benefit by inclusion of a data element providing a phonetic algorithm result based on soundex, metaphone, double metaphone or other phonetic algorithms.

As previously mentioned, preserving the blank spaces between words in a proper names is essential. Therefore, a method for creating a dictionary capable of storing proper names composed of two or more words is important. Furthermore, permanently preserving blank spaces making up the proper name entries is essential to maintaining accurate dictionary entries. For example, when “Fort Henry” is divided into two words “Fort” and “Henry”, the original entry “Fort Henry” is lost forever.

Since there are an extraordinarily large number of proper names, segregating proper names into a plurality of dictionaries has obvious benefits. Filtering proper names based on a specific classification enables construction of a plurality of segregated dictionaries. Entries may be heuristically and or semantically analyzed based on user defined sub-groups. These sub-groups can be anything the user selects. Proper names are then stored in the appropriate dictionary based on sub-group descriptors; entries are cross indexed when stored in the dictionary thus allowing relational queries to be performed throughout the plurality of dictionaries.

### SUMMARY OF THE INVENTION

Linguistic experts throughout the world agree that the terms “proper names” and “proper noun” are heuristically and semantically identical. More specifically, proper nouns and proper names are considered the same type of part-of-speech.

In the following descriptions, discussions and claims, the term “proper name” will be used however it should be understood that the term “proper noun” can be interchanged without any difference in the intent of the descriptions, claims, functionality, advantages or benefits associated with this invention.

The present invention provides numerous advantages over prior art by providing a method for creating one or more dictionaries with entries that are restricted to proper names.

It is an objective of the present invention to provide a method for creating one or more dictionaries composed entirely of proper names.

It is another objective of the present invention to provide an automated method of creating one or more dictionaries of proper names.

It is a further objective of the present invention to prevent entries from being unintentionally parsed resulting in deletion, substitution or contamination of proper name entries.

It is a further objective of the present invention to present a method for creating a dictionary that has a novel set of data elements and does not include data elements for lemmas, suffixes, affixes; these data elements are prevalent in current dictionaries but are not applicable to dictionaries composed entirely of proper names.

It is a further objective of the present invention to provide a method for construction of a dictionary that is not language dependent.

It is a still further objective of the present invention to provide a method for creating a dictionary that includes a data element with a frequency of occurrence parameter.

It is a still further objective of the present invention to provide a method for creating a dictionary that includes a data element with the number of syllables in each proper name.

Yet, another advantage of the present invention is to provide a data element with a phonetic algorithm result.

Finally, the present invention provides a method to produce a plurality of dictionaries with a cross index parameter allowing relational data searches or queries between all dictionaries.

Limiting a dictionary to proper names provides a novel method that may be utilized in computer applications and databases, the dictionary may also be published as a reference book. The dictionary provides great utility when incorporated in an electronic device such as a cell phone, handheld computer devices or spell-checking style, electronic devices.

The above advantages of the present invention, in addition to many others, will become more easily understood after reviewing the following detailed description of the disclosed embodiments, drawings and claims of the present invention.

### BRIEF DESCRIPTION OF THE DRAWINGS

FIG. 1 is a schematic diagram showing a possible computer system configuration for use with the present invention.

FIG. 2 is a schematic diagram showing the operational modules for one embodiment of the present invention.

FIG. 2A is a schematic diagram showing the operational modules for an alternate embodiment of the present invention.

FIG. 3 is a schematic diagram showing the operational module used to retrieve data.

FIG. 4 is a schematic diagram providing details about the operational module for the parse operation.

FIG. 5 details the advantages of the space preserve operation.

FIG. 6 is a flow chart for the filter operation.

FIG. 7 shows an embodiment of the structure for a target dictionary.

FIG. 8 details an implementation for an embodiment of the data creation and entry storage operations.

FIG. 9 is a schematic diagram showing the embodiment for the creation of a plurality of dictionaries.

FIG. 10 details selecting target dictionaries from a plurality of dictionaries.

FIG. 11 is schematic diagram showing the operational modules for an alternate embodiment of the present invention.

### DETAILED DISCUSSION OF DRAWINGS

While embodiments of this invention can take many different forms, specific embodiments thereof are shown in the drawings and will be described herein in detail with the understanding that the present disclosure is to be considered as an exemplification of the principles of the invention and is not intended to limit the invention to the specific embodiments illustrated.

Linguistic experts throughout the world agree that proper names and proper nouns are heuristically and semantically identical. More specifically, from a parts-of-speech consideration the terms “proper nouns” and “proper names” are considered equivalent and interchangeable.

In the following descriptions and discussions, proper names will be used however it should be clearly understood that proper nouns can be equally interchanged without any discernable difference in the intent of the descriptions, claims, functionality, advantages or benefits associated with this invention.

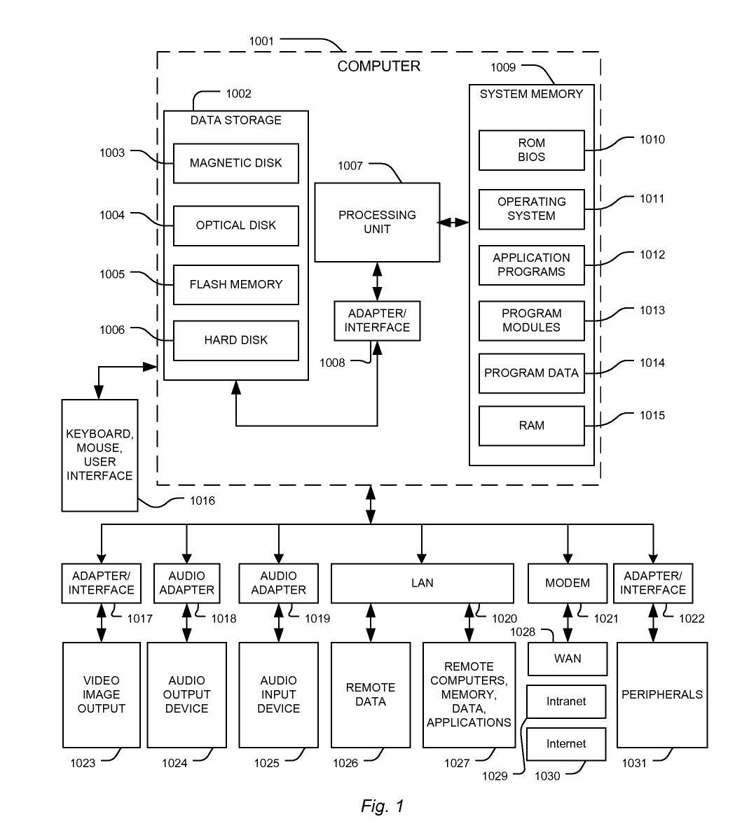

FIG. 1 provides an example of a computer environment that may be used for a computer implementation of the invention. The invention does not have any limitation to be performed by a computer and as a result may be performed manually or by any suitable device.

Computer environment 1001 represents a system with a processor or processing unit 1007. The processing unit 1001 interacts with system memory 1009. System memory 1009 may contain a Rom Bios 1010, operating system 1011, application programs 1012, program modules 1013, program data 1014 and RAM 1015.

Computer environment 1001 provides data storage 1002. Such data storage may consist of one or more of the following hardware components: magnetic drive 1003, optical disk 1004, flash memory 1005 and hard disk 1006.

Data storage 1002 is available to the processing unit 1007 by means of adapter/interface 1008.

Users or operators may control computer environment 1001 through user interfaces 101 6. Such interfaces 1016 are commonplace and may be a mouse, touch screen, touch pad, keypad, headset, audio control system, optical control system, telephone interface, internet interface or global positioning system interface.

Computer environment 1001 may be configured for input and outputs through peripheral devices. Such devices may include video image output 1023 connected to adapter/interface 1017.

Audio output device 1024 can be used to provide audio output through audio adapter 1018. Audio input device 1025 may be configured to provide audio input to computer environment 1001 through audio adapter 1019.

Computer environment 1001 is capable of bi-directional data exchange by means of LAN 1020 with remote data 1026. Computer environment 1001 is configurable to interact and co-process instructions and information through LAN 1020 communicating with remote computers, remote memory, remote data, and remote applications 1027.

Modem 1021 may be used to connect computer 1001 with WAN 1028, intranet 1029 and internet 1030.

Additional peripherals 1031 may be utilized by computer environment 1001. These peripherals may find it advantageous to connect through adapter/interface 1022.

Peripherals 1031 may include optical scanners, voice recognition systems, bar code scanners, RFID devices, digital cameras, medical imaging devices, digital video imaging, and data output devices.

It should be noted that FIG. 1 serves to provide details of one possible computer environment that may be utilized, however this is one possible embodiment of the invention and does not serve as a precise definition of a computer environment.

In the preferred embodiment, the method will be performed using a computer or system of networked computers. However, this should not be considered a restriction to this invention. The method can be performed manually by a human operator, network computer system, cloud computing environment, or an electronic device, such as a cell phone or mobile computing devices, as well as other implementations.

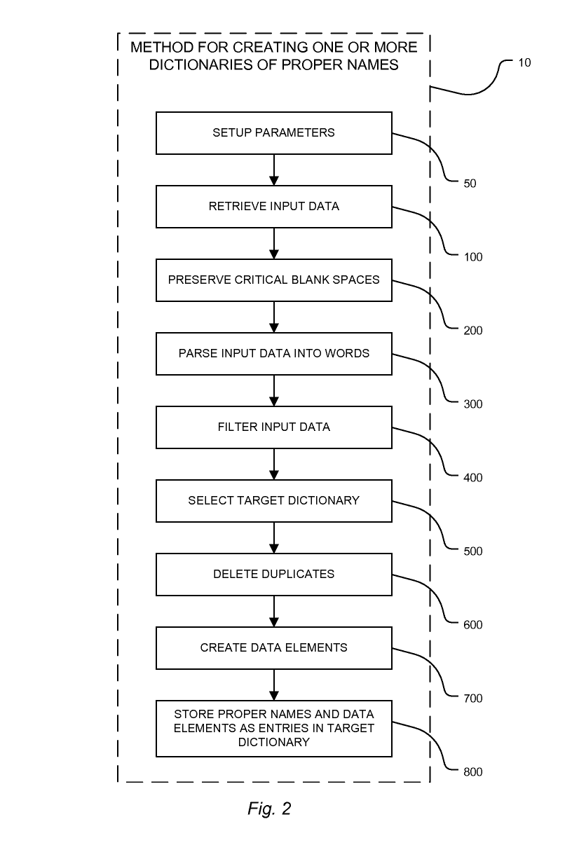

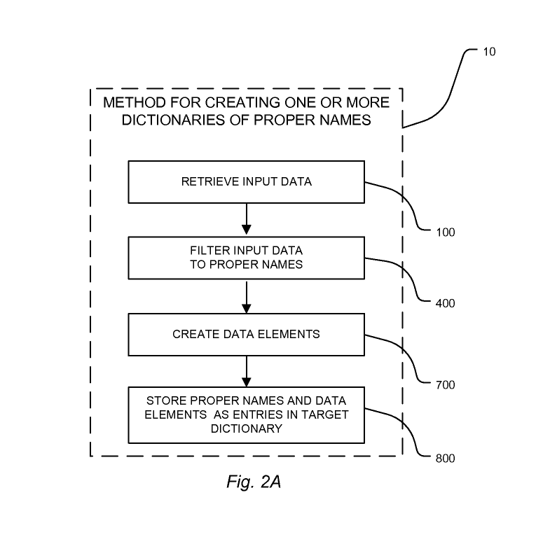

FIG. 2 illustrates a preferred embodiment of the invention. The figure details the individual steps for creating a dictionary restricted to proper names. FIG. 2 details the major operational steps for creating a dictionary of proper names. In this embodiment, the overall method is indicated in FIG. 2 by block 10. The user may vary, add, or omit steps to vary the characteristics of the final dictionary that is created. It is important to note that a user may elect to skip one or more individual steps to better tailor the process based on the requirements of the desired dictionary. The embodiment of the invention that are shown in FIG. 2 can take many different forms and some operational steps may be omitted or combined with other operational steps; it should be clearly understood that such omissions or modification to the embodiment do not limit or affect the spirit or scope of the invention.

In this embodiment, user preferences, application data, computer information, installation data and other implementation variables are stored as setup parameters during the setup parameters initialization shown in FIG. 2—block 50. These parameters are available for reference throughout all operations and provide user preferences and important information throughout all steps of the process.

Operation 100 retrieves input data and is capable of utilizing input data in an unlimited number of formats. Input data can consist of, but is not limited to any of the following: audible words, written words, scanned words, published articles, published books, web blogs, radio broadcasts, television broadcasts, internet web pages, government databases, financial records, computer files, computer documents, computer word processing data, text files, raw text files, structured text files, or computer-developed, data sets consisting of lexical items. Operation 100 retrieves input data and performs any necessary data conversion required for subsequent operations.

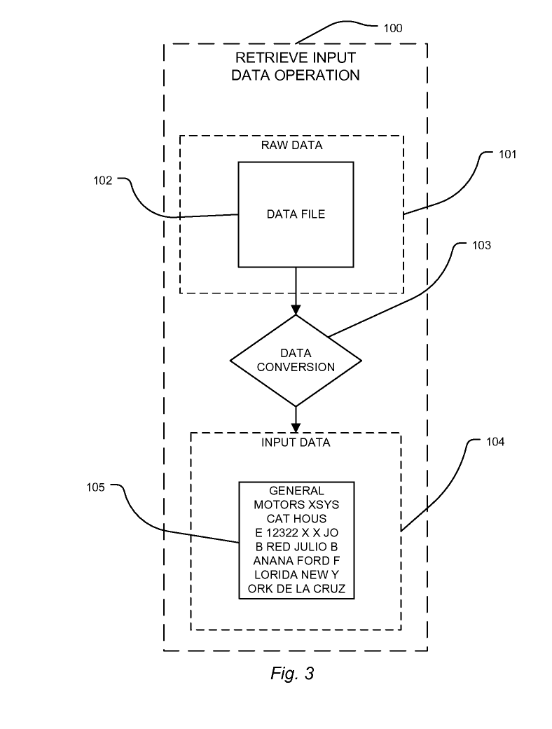

Continuing to reference FIG. 2, block 100 shows the process for retrieving input data. FIG. 3 provides additional details of operation 100. Raw data 101 may contain a plurality of data files or sets of raw data. Data file 102 represents one incoming set of raw data. Data conversion module 103 extracts, analyzes and converts the information contained in data file 102. The processed data is stored in input data block 104. The data file 105 provides an example of data after it has completed the operation.

When dealing with unstructured, data formats, the blank spaces between lexical character strings are indiscernible from word breaks. Step 200 in FIG. 2 preserves all required blank spaces. Step 200 may utilize a heuristic and or semantic content analyzer. Step 200 analyzes lexical characters strings and determines which blank spaces in proper names are critical and need to be retained. An example of a blank space is found in the following proper name: “New York”. Failure to preserve the blank space between words “New” and “York”, will lead to “New York” being erroneously separated into the two separate words: “New” and “York”. Obviously, failure to preserve the blank spaces within any proper name will lead in erroneous and possibly worthless data.

In this embodiment of the present invention, step 200 is highly effective at preserving critical spaces within words and proper names; it enables the subsequent analyses and operations to occur without data being erroneously separated into two or more individual words.

Block 300 in FIG. 2 identifies the operation responsible for parsing lexical character sets into individual words and proper names. This step analyzers characters, lexical items, words, proper names and phrases and then parses the input data into proper names. Extraneous punctuation, spaces, and characters are discarded; the parsing operation 300 outputs words and proper names that can be further modified and analyzed in following operations.

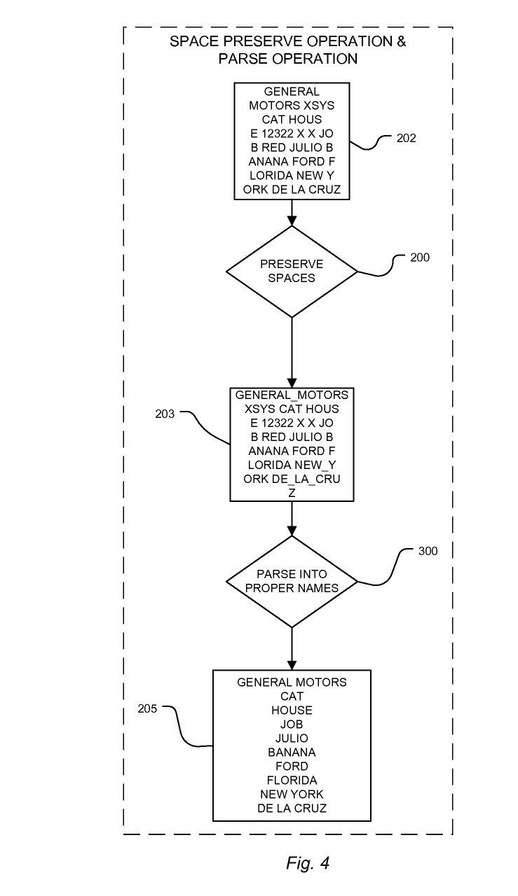

FIG. 4 shows input data 202 which is a disjointed and incomprehensible set of lexical characters strings. Operation 200 uses semantic and heuristic analyzers to: (1) locate blank spaces between words, (2) determine word breaks, and (3) locate and preserve blank spaces within words and proper names. Operation 200 preserves blank spaces of input data 202 and is essential to producing accurate data.

Block 203 shows the input data after it has been processed by operation 200; blank spaces have been preserved using a space preserving character. In this instance, the character “_” has been used however in general practice other characters will serve the same functionality.

After operation 200, input data 203 is parsed in operation 300. As previously stated, the parsing operation breaks the lexical character strings into separate individual words and proper names. The resulting data is illustrated in block 205. The parsing operation 300 removes extra spaces, extraneous lexical characters, punctuation, and non-critical spaces. Data 205 is filtered and separated into meaningful words and proper names.

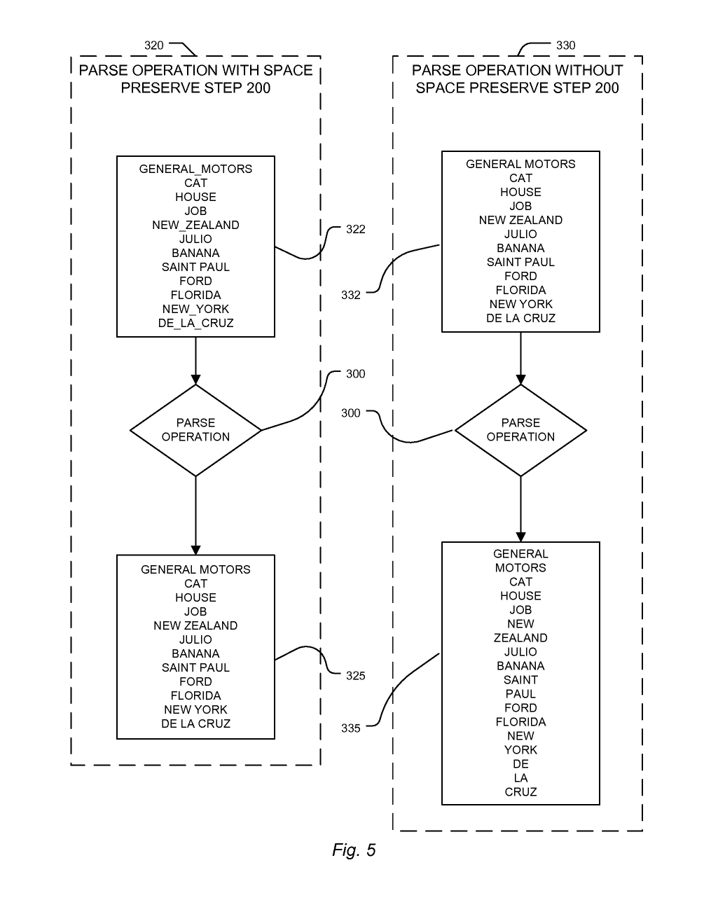

FIG. 5 details the importance of preserving blank spaces and accurately parsing data. Block 320 shows input data set 322 before parse operation 300. Blank spaces were preserved during the space preserving operation indicated by block 200 in FIG. 2.

Returning to FIG. 5, the quality of the data is apparent by taking a look at the data in block 325; this represents the data after the parse operation. All of the proper names remain intact.

Examining block 330 in FIG. 5 shows the benefit of the space preserve operation. The data in block 330 has not had a space preserve operation, the data then undergoes parse operation 300. The resulting data set 335 consists of 18 separate words. The original five proper names: (a) “GENERAL MOTORS”, (b) “NEW ZEALAND”, (c) “SAINT PAUL”, (d) “NEW YORK”, (e) “DE LA CRUZ” were improperly broken into single words. As a result, the five proper names were permanently lost from the input data set and the data has been forever corrupted.

Returning to FIG. 2, following completion of the space preserving and parsing operations, the input data is filtered in operation 400. Filtering criteria are selected based on the requirements for the final dictionary. Operation 400 allows the user to select an unlimited variety of single or multiple filter criteria. Operation 400 filters the input data to restrict the input data to proper names; thus creating a dictionary restricted to proper names.

Other filter operations can be performed to select words based on parts-of-speech criteria. In fact, operation 400 can be omitted, or conversely set to other filter criteria based on user's requirements. Operation 400 does not need to be limited to filtering input data to proper names. A person skilled in the art of creating dictionaries will understand that the filter criteria of operation 400 allow a user to produce a plurality of different dictionaries.

The filter operation can be used to restrict the input data to first names, last names, street names, city names, state names, province names, country names, company names or any specific category of proper names.

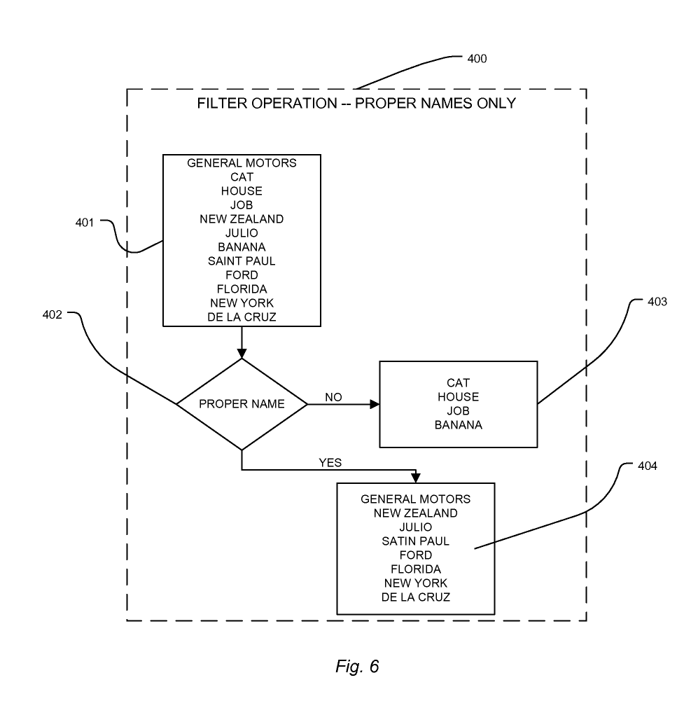

An example of a filter operation appears in FIG. 6. Block 400 shows data at various steps of the filter process. The data in block 401 contains a set of words and proper names. Block 402 is a filter that analyzes a data group one character string at a time and determines whether that character string is a proper name. It then advanced to the next character string until the entire data group has been analyzed.

Character strings that are determined to be proper names are stored in data group 404. By reviewing the data in group 404, it can be seen that the data is restricted to proper names.

Data that does not satisfy the filter 402 requirements are not proper names and therefore isolated to data group 403. By reviewing data block 403, it is apparent that “Cat”, “House”, “Job”, “Banana” are not proper names. Filter 402 has completed the operation successfully.

In this example, filter 402 restricts input data to proper names. A filter or series of filters may be based on user's preferences or requirements for the resulting data. Users can create an unlimited variety of dictionaries by altering the parameters of filter 402.

The next operation shown in FIG. 2 is operation 500. This operation selects the target dictionary. Selection of the target dictionary may be performed automatically or manually. Information about the target dictionary may be stored in the setup parameters (block 50) and retrieved.

Automating operation 500 allows a user to set various parameters, these selections are saved and automatically loaded each time the method is run thereafter.

The target dictionary selection may be automated by means of semantic analysis or heuristics methods. For example, a user may decide to select a different target dictionary for each word in the input data. Using a semantic analyzer can automate the process and assist in processing high volumes of data.

If the input data set was composed of the following words: John, Benjamin, Harold. It would be a good choice to use a dictionary for proper names, or perhaps a dictionary of first names. Therefore, the target dictionary in operation 500 would be set to a dictionary of first names.

Another project could include the following input data: New York, Paris, Boulder. For this input data, a dictionary of cities would be appropriate. Therefore, the target dictionary in operation 500 would set to select a dictionary of cities.

A more challenging input data set could consist of the following: John, Benjamin, Harold, New York, Paris, Boulder, Montana, IBM, Ford, and Pietrelcina. This data would benefit if the target dictionaries were selected for the input data set on an entry by entry basis. This could be performed manually, automatically or semi-automatically.

Dictionaries may be limited to a certain part of speech, proper names, medical terms, legal terms, animals or any other type that a user may desire.

Block 600 (FIG. 2) shows the delete duplicate operation. This operation allows the user to eliminate duplicate entries prior to storing the entries in the dictionary. If the input data set contains the following: John, John, Harry, Bob, Bob, Bob and the target dictionary contains entries: Joe, Bob, Henry; the input data needs to be reduced to names not currently present in the dictionary. John and Harry are unique and new entries. After updating, the target dictionary contains: John, Harry, Bob, Joe, Henry.

Block 700 in FIG. 2 identifies the creation of data elements operation. This operation adds related information to each entry in the input data set. Based on user preferences, a variety of information can be selected. For example, in one preferred embodiment, a user may elect to create a dictionary with two data elements. The first data element could contain spelling information about each entry. The second data element could contain a specific proper name descriptor. User preferences can be stored and recalled from step 50 or may be manually selected at step 700. The disclosed invention allows for an unlimited number and variety of a data elements to be created and the previous example should not be considered a limitation of this invention.

The creation of data elements operation adds required data elements for proper names in the input data. For example, if the user has selected spelling information and number of syllables as the desired data elements and the input data set contains: “Bob”, “Henry”, “New York”, “Oak”, and “Budweiser”. The creation of data elements operation would create four entries with two data elements each. The data elements would include: (1) correct spelling data element and (2) number of syllables data element. The results would be as follows: Entry No. 1, Bob, 1 syllable; Entry No. 2, Henry, 2 syllables; Entry No. 3, Oak, 1 syllable; Entry No. 4, Budweiser, 3 syllables.

The storage operation is identified as block 800 (FIG. 2). This step stores proper names and data elements as entries in the target dictionary. If the target dictionary is new and does not have any entries, the current batch of entries will be the first to be entered. If the target dictionary exists and has a plurality of entries, the current batch of entries will be stored in the target dictionary along with existing entries.

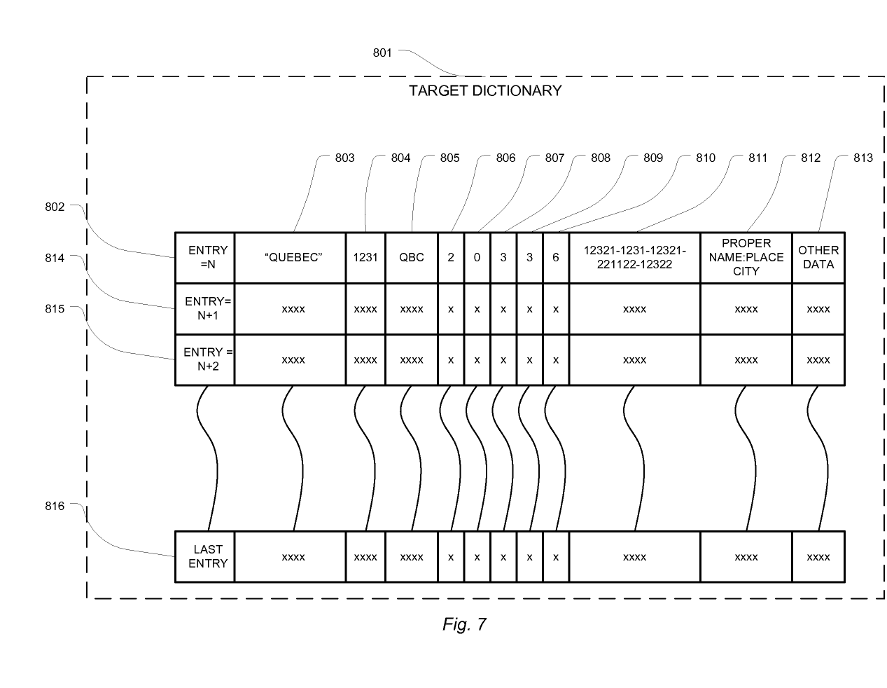

FIG. 7 provides an example of a target dictionary. It should be understood that great flexibility is possible with regard to the number of entries and data elements in a target dictionary. This example is only one preferred embodiment of the present invention, and should not be considered a limitation to the configuration of entries or data elements. The final configuration of a target dictionary can be customized based on user requirements.

Block 801 shows the target dictionary. Block 802 shows the first entry in the target dictionary. The number of possible entries in a target dictionary is unlimited. Each row is an entry. Row 814 is the second entry; row 815 is the third entry. The last entry is identified as block 816.

The data elements are blocks 803 through 813. In this example, there are eleven data elements with information about each entry. Data elements are user defined and may contain any information that a user would like to associate and store in the target dictionary.

Data elements can contain, but are not limited to, spelling information, number of characters, number of vowels, number of syllables, phonetic algorithm result, semantic definitions, proper name descriptors, heuristic evaluations, census data, frequency of occurrence parameters, relative usage descriptors, geographic information, cross indexes to other dictionaries, creation date, modification date, historical date references, number of words, and a gender descriptor. Users can create an unlimited amount and variety of data elements.

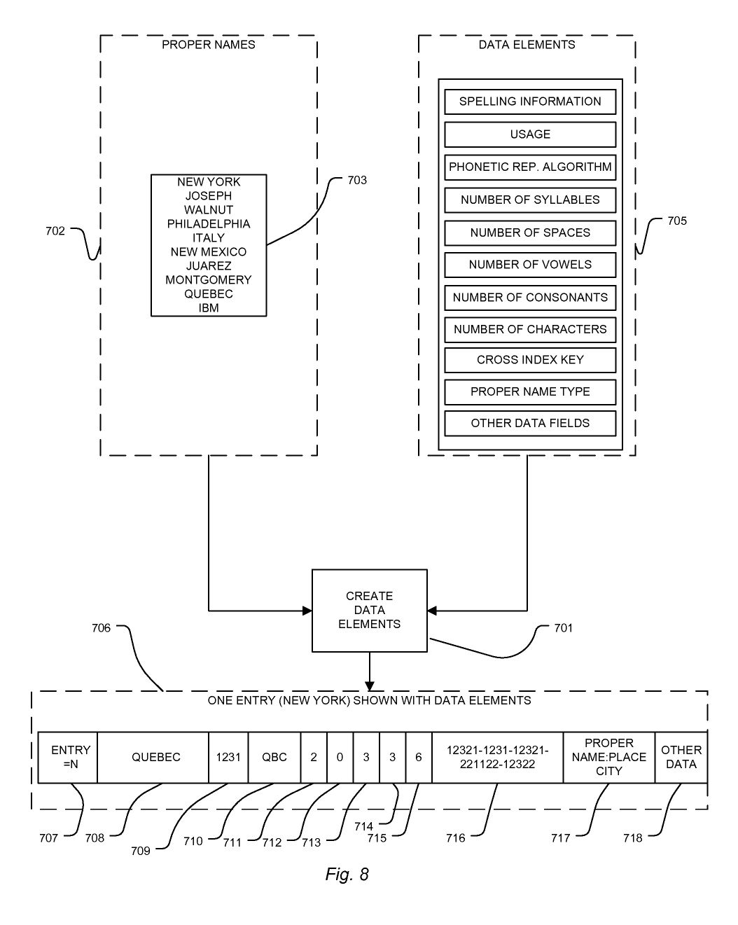

In FIG. 8, data elements are shown in block 705. Block 701 shows the data element creation module. This module calculates, locates, and retrieves the required information for each data element in block 705.

Block 702 indicates a data group of proper names; this data group consists of one or many individual data sets. One data set is shown in block 703. The create data elements operation is performed for each data set in block 702 or in this example, the proper names in the input data group 703.

After all data elements have been created; proper names and data elements are available for storage in the target dictionary. Block 706 shows dictionary entry for the proper name “Quebec”. Data elements are shown in blocks 708 through 718. It will be readily appreciated by those skilled in the art that the data is not limited to the data elements shown. Referring once again to FIG. 8, data elements have been created for the following: spelling information (block 708), frequency of occurrence (block 709), (3) phonetic algorithm result (block 710), number of syllables (block 711), number of spaces (block 712), number of vowels (block 713), number of consonants (block 714), number of characters (block 715), cross index key (block 716), proper name type (block 717), and other data (block 718).

Returning to FIG. 2, in one embodiment of the invention, block 800 represents the operation of storing proper names and data elements as entries in a target dictionary. This operation adds the entries and data elements to the target dictionary.

In one embodiment of the invention, FIG. 7 shows a target dictionary with entries that were stored by the storing operation mentioned above. A possible embodiment of a target dictionary is shown in block 801. The figure shows a plurality of entries and associated data elements. The present invention does not have any limitation on the number or type of data elements that can be added to a dictionary.

The first entry to the dictionary is indicated as row 802. This entry is for “Quebec”. This first entry includes data elements 803 through 813. In this embodiment, rows 814, 815 and 816 represent the second, third and last entries in the dictionary. These rows are illustrated to give the reader an understanding of one possible structure of a target dictionary.

FIG. 2A provides a second embodiment of the present invention. In this alternate embodiment of the invention, various operational modules from the first embodiment (FIG. 2.) are omitted. The embodiment shown in FIG. 2A includes the four operational modules shown in block 10. This streamlined embodiment start with retrieving input data; this is shown in block 100. The input data is filtered to only accept proper names as shown in block 400.

In other preferred embodiments of the inventions, the filter operation can be used to restrict the input data to first names, last names, street names, city names, state names, province names, country names, company names or any specific category of proper names.

User specified data elements are created—block 700. Entries and data elements are stored in the target dictionary during the operation shown in block 800. This embodiment results in the creation of a dictionary of proper names and associated data elements.

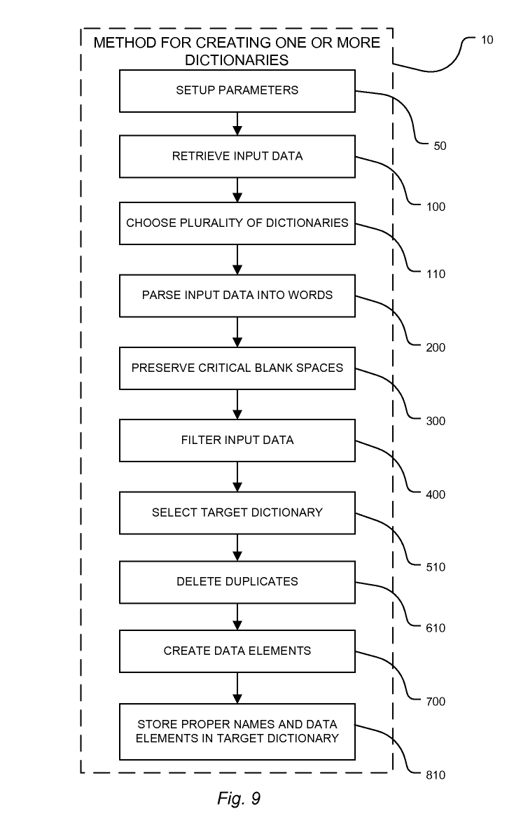

FIG. 9 illustrates a third embodiment of the present invention. In this third embodiment of the invention a plurality of dictionaries is being created. A plurality or series of dictionaries allows input data to be stored in a series of different target dictionaries. Entries are stored in one or multiple target dictionaries.

In prior embodiments of the invention a single target dictionary was the depository for the entire input data set. Providing a plurality of dictionaries allows greater flexibility with regard to the number and types of resulting dictionaries.

In this embodiment of the invention, some operations are similar or common to those described in the embodiments that result in the creation of a single dictionary. Creating a plurality of dictionaries requires some additional steps. The first additional step involves choosing a plurality of dictionaries. A plurality or series of dictionaries is selected for use with the input data set and from within this series of dictionaries, the most appropriate target dictionary may be selected for storing the input data.

It should be appreciated that a single target dictionary or a plurality of target dictionaries can be created based on the user's preference and the diversity of the input data. When a user creates or add entries to a plurality of dictionaries, the user must select which plurality of dictionaries is to be used—this only applies to instances when there are more than one plurality of dictionaries.

Directing our attention to FIG. 9, the method of this embodiment is shown in block 10. In this embodiment of the invention, a target dictionary is selected from a plurality of dictionaries.

Block 50 shows the operation responsible for creating, modifying and storing setup parameters. These parameters assist with automating other steps of the process. Block 100 shows the process for retrieving input data.

A plurality of dictionaries to be used during the method is selected during the operation in block 1 10. The selected plurality of dictionaries consists of multiple dictionaries featuring proper names that may be categorized or restricted based on certain heuristic, semantic or other criteria.

Input data may consist of lexical character sets where words and proper names are not clearly defined. The input data must be broken or parsed into words and proper names.

Extraneous punctuation, numbers and unintelligible data is discarded during the operation shown in block 200.

As mentioned in an earlier embodiment, blank spaces must be preserved to maintain data integrity. This operation occurs in block 300 of the embodiment.

At this point in the method, the input data consists of words, proper names and other linguistic components. The present invention is for creating a dictionary restricted to proper names and therefore, at this point in the process, the input data is filtered. Character strings that are determined to be proper names are retained for subsequent operations. Data that does not meet the proper name criteria is omitted. The filter operation is shown in block 400.

In this embodiment a plurality or series of dictionaries are being used. The number of dictionaries is unlimited and a common theme may or may not exist between the dictionaries within the plurality of dictionaries. As a result, a target dictionary must be selected for each entry prior to storing the entry and data elements. This process may occur on an entry by entry basis or a user may elect to store all of the input data in a single target dictionary. This selection process is performed during operation shown in block 510.

In this embodiment of the invention, input data is compared against the entries in the target dictionary. Duplicates are deleted from the input data. This operation is shown in the schematic representation of this invention in FIG. 9—block 600.

A target dictionary must be selected from the plurality of dictionaries. This selection must occur for each entry in the input data set. The entries and data elements are then stored in the target dictionary based on this selection. In this embodiment of the invention, the target dictionary selection may be made for each entry or one target dictionary may be selected for the entire data set. If the target dictionary is selected on an entry by entry basis, a user selects one target dictionary for an entry and then may select a different target dictionary for the next entry—therefore, target dictionary selection may be made on an entry by entry basis. Entries and associated data elements are then stored in the selected target dictionaries during the storage operation indicated in block 810.

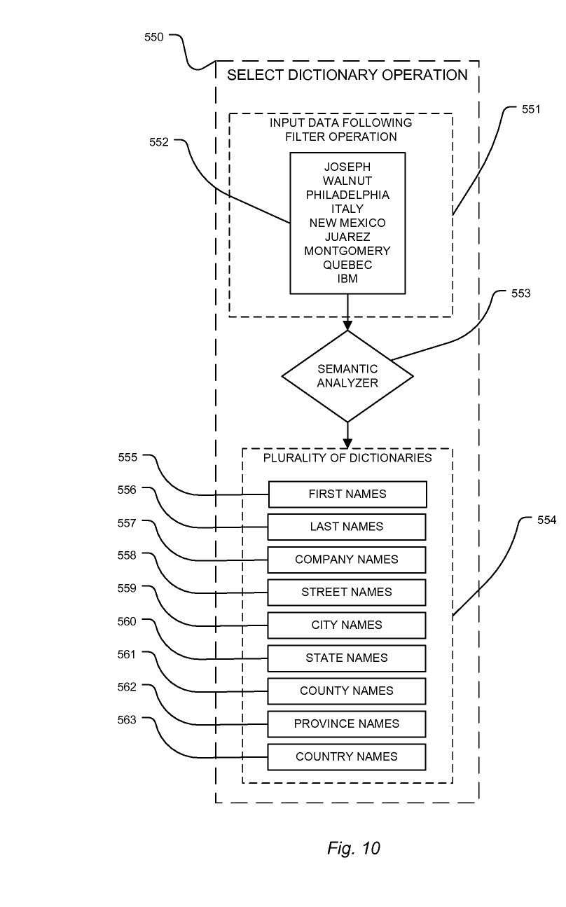

FIG. 10 shows input data being stored in a plurality of target dictionaries. In this embodiment of the invention, a plurality of target dictionaries is shown in block 554. This plurality of target dictionaries is not meant to serve as a restriction or limitation on the number or types of target dictionaries that may be used. A person skilled in the art will understand that the present invention gains function from the ability of a user to create custom groups of target dictionaries.

Blocks 555 through 563 represent individual target dictionaries. Dictionaries may be restricted to first names, last names, full names, artist names, medicine names, author names, product names, company names, street names, city names, state names, county names, province names, country names or other custom dictionaries that a user may require.

In this embodiment of the invention, input data is shown in block 551. A sample of input data is shown in block 552. This input data may go through an automated semantic analyzer as shown in block 553. This determines the target dictionary where it should be stored. Input data may also be manually sorted by a user; the user will then select the appropriate dictionary for entries.

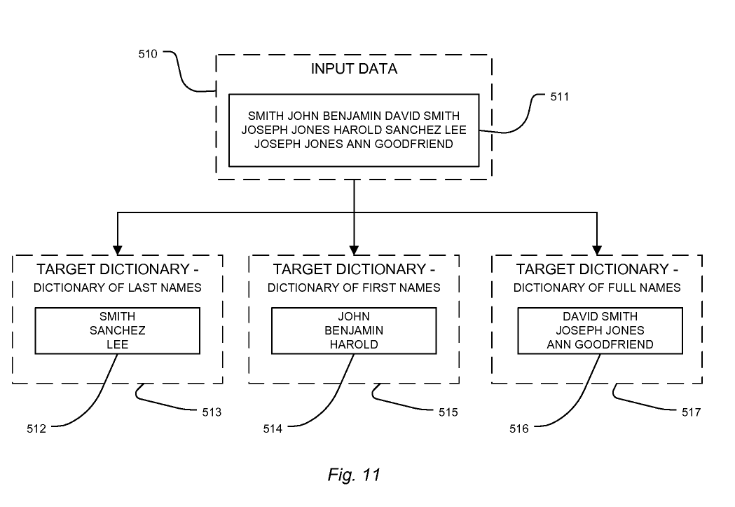

FIG. 11 provides an example of an input data set being stored in a plurality of dictionaries. In this case, there are three target dictionaries; they are last names, first names and full names; the dictionaries are shown in blocks 513, 515, 517, respectively.

The data shown in block 511 is analyzed. In this example, each entry is then stored in one of the three dictionaries. Three dictionaries are indicated by blocks 512, 514 and 516. Block 513 shows a dictionary of last names—entries are visible in block 512.

Similarly, block 515 shows a dictionary of first names and block 514 shows entries in the dictionary. It will be appreciated that block 517 shows a dictionary of full names. Block 516 shows input data that qualified as full names and is stored in the dictionary.

It will be appreciated, that the present invention may be implemented in numerous different ways. The computer program product, computer software, data storage method or hardware device type may be altered as described. It should be thoroughly understood that the present invention is not limited to the embodiment described above with reference to the drawings, the method may undergo alterations involving modifying the order that major operation are performed, operations may be added and omitted, users may add or change data elements and countless other modification may be made to this invention without affecting the spirit and scope of the invention.

Although the present invention has been described with references to preferred embodiments, workers skilled in the art will recognize that modifications may be made to the form and detail of the present invention without departing from the scope and spirit of the invention.

What is claimed is:

1. A method for creating a dictionary restricted to proper names, comprising: retrieving input data; filtering input data to only include proper names; creating data elements including a data element with spelling information for each proper name; and storing proper names and data elements as entries in target dictionary.

2. The method of claim 1, wherein creating data elements further comprises a second data element with at least one phonetic algorithm result for each proper name.

3. The method of claim 1, wherein creating data elements further comprises a second data element with the number of syllables in each proper name, a third data element with a measure of the frequency of occurrence of each proper name in written and spoken language and a fourth data element with at least one phonetic algorithm result for each proper name.

4. The method of claim 1, wherein creating data elements further comprises a second data element with the number of syllables in each proper name and a third data element with a measure of the frequency of occurrence of each proper name in written and spoken language.

5. The method of claim 1, wherein creating data elements further comprises a second data element with a measure of the frequency of occurrence of each proper name in written and spoken language and a third data element with a phonetic algorithm result for each proper name.

6. The method of claim 3, wherein the filtering step further comprises the step of: restricting input data to first names of people or persons.

7. The method of claim 1, wherein the filtering step further comprises the step of: restricting input data to last names of people or persons.

8. A method for creation of a dictionary restricted to proper names, comprising: retrieving input data; preserving blank spaces within input data; parsing input data character sets into words and proper names; filtering input data to only include proper names; selecting a target dictionary; deleting proper names from input data if they are entries in the target dictionary; creating data elements including a data element with spelling information for each proper name and a second data element with a measure of the frequency of occurrence of each proper name in written and spoken language; and storing proper names and data elements as entries in target dictionary.

9. The method of claim 8, wherein the filtering step further comprises restricting input data to first names of people or persons.

10. The method of claim 8, wherein the filtering step further comprises restricting input data to last names of people or persons.

11. The method of claim 8, wherein the filtering step further comprises restricting input data to street names.

12. The method of claim 8, wherein the filtering step further comprises restricting input data to city names.

13. The method of claim 8, wherein the filtering step further comprises restricting input data to state names.

14. The method of claim 8, wherein the filtering step further comprises restricting input data to province names.

15. The method of claim 8, wherein the filtering step further comprises restricting input data to country names.

16. The method of claim 8, wherein the filtering step further comprises restricting input data to company names.

17. A method for creation of a plurality of dictionaries restricted to proper names, comprising: retrieving input data; choosing a plurality of dictionaries based on semantic analysis of the input data; preserving blank spaces within input data; parsing input data character sets into words and proper names; filtering input data to only include proper names; selecting a target dictionary for each proper name based on semantic analysis; deleting proper names from input data if they are entries in the target dictionary; creating data elements including a data element with spelling information for each proper name; and storing proper names and data elements as entries in target dictionary.

18. The method of claim 17, wherein the step of creating data elements includes a second data elements with an index key that enables relational queries to be performed between entries in the plurality of dictionaries.

19. The method of claim 18, wherein the step of creating data elements includes a third data element with at least one phonetic algorithm result and a fourth data element with a measure of the frequency of occurrence of each proper name in written and spoken language.

20. The method of claim 19, wherein the step of creating data elements includes a fifth data element with the number of syllables in each proper name.
